(19) United States
(12) Patent Application Publication
(10) Pub. No.: US 2015/0001804 A1
(43) Pub. Date: Jan. 1, 2015

(54) FLUID SEAL ASSEMBLY WITH WEAR RING

(71) Applicant: Yefim Epshetsky, Schaumburg, IL (US)

(72) Inventor: Yefim Epshetsky, Schaumburg, IL (US)

(73) Assignee: AKTIEBOLAGET SKF, Goteborg (SE)

(21) Appl. No.: 13/929,401

(22) Filed: Jun. 27, 2013

(51) Int. Cl. F16J 15/26

(52) U.S. Cl. CPC F16J 15/26
USPC 277/306; 277/370

(57) ABSTRACT

A fluid seal assembly (the assembly) of the present invention is disposed between an outer surface, i.e. engine block or any other part that requires application of the assembly and a rotatable member, such as, for example a shaft, wherein the assembly circumscribes the shaft and lubricated the shaft and the same rotates around the axis. The assembly includes a casing unit, a sealing ring unit, and an intermediate member. The intermediate member is positioned on the shaft and frictionally engaged a seal of the sealing ring unit in order to eliminate frictional engagement between the shaft and the seal.

### FIELD OF THE INVENTION

The present invention relates to seal assemblies, and more particularly to wear sleeves for seal assemblies for sealing about rotating shafts.

### BACKGROUND OF THE INVENTION

Fluid seals assemblies of various types are used in numerous applications including and not limited to sealing vehicular engine crankshafts, transmission shafts, bearing lubrication systems, compressor shaft support assemblies, and the like. The typical fluid seal assembly is designed to retain and seal oil or grease in a predetermined location for lubricating the shaft and to prevent ingress of environmental contaminants The art is replete with various prior art references teaching numerous seals designs adaptable to retain and seal oil or grease in a predetermined location for lubricating the shaft. These prior art references include and are not limited to U.S. Pat. Nos. 3,929,340 to Peisker; 4,336,945 to Christiansen, et al.; 4,501,431 to Peisker et al., 4,667,968 to Nash et al., 4,886,281 to Ehrmann et al.; 4,969,653 to Breen, 6,213,476 to Chandler et al., 6,620,361 to Longtin et al., and 6,736,404 to Shuster.

The typical fluid seal assembly includes a casing unit, a flexible sealing member having a sealing lip adapted to engage against a sealing surface of a relatively rotatable member, such as the shaft. The flexible sealing member includes a body portion extending to an annular flex portion of reduced cross-sectional thickness bonded to the metal case member and located intermediate the seal lip and metal case. After a period of use, the outer surface of the shaft (and the inner surface of the sealing member) wears away to the extent that the seal member inner surface no longer seats properly against the shaft outer surface. In such cases, either the shaft and/or the seal member are replaced, or more preferably, a device known as a “wear sleeve” or sometimes called “speedy sleeve” is mounted to the shaft at the sealing location. Such a sleeve increases the shaft outside diameter in the vicinity of the seal to thereby restore proper sealing. Such wear sleeve designs are disclosed in U.S. Pat. Nos. 5,209,499 to Ruff, Jr. et al. and 8,439,363 to Greca et al. The U.S. Pat. No. 5,209,499 to Ruff, Jr. et al., for example teaches a casing unit, a flexible sealing member, a shaft with the casing unit surrounding the shaft. A wear sleeve is sandwiched between the shaft and the sealing member and is mounted to the shaft at the sealing location.

The wear sleeve increases the shaft outside diameter in the vicinity of the seal to restore proper sealing. The wear sleeve is stamped in order to define a central sleeve portion that sits on the shaft and a pair of extension portions extending perpendicularly to the axis of the shaft with one of the extension portion further extending to a radial lip that is in parallel and spaced away from the central sleeve portion. Those skilled in the stamping art will appreciate that the process of fabricating the wear sleeve of such cross section will require multi-step stamping process in order to form the wear sleeve with the cross section as taught by the U.S. Pat. No. 5,209,499 to Ruff, Jr. et al.

Another prior art reference, namely the U.S. Pat. No. 8,439,363 to Greca et al., teaches a casing unit, a flexible sealing member, a shaft with the casing unit surrounding the shaft. A wear sleeve is sandwiched between the shaft and the sealing member and is mounted to the shaft at the sealing location. A resilient member is attached to the inner side of the wear sleeve and is sandwiched between the wear sleeve and the shaft. Similar to the seal design taught by the U.S. Pat. No. 5,209,499 to Ruff, Jr. et al., the wear sleeve disclosed in the U.S. Pat. No. 8,439,363 to Greca et al., is stamped in order to define a central sleeve portion that sits on the shaft and a pair of extension portions extending perpendicularly to the axis of the shaft whereafter the aforementioned resilient member is attached to the inner surface of the wear sleeve. This design and method of assembly is complicated and therefore not cost effective.

Although such wear sleeves taught by the U.S. Pat. Nos. 5,209,499 to Ruff, Jr. et al. and 8,439,363 to Greca et al., are generally satisfactory solutions to the problem of shaft (and seal) wear, care must be taken when installing the wear sleeve as known wear sleeves are typically thin-walled and press-fitted onto the shaft. If the sleeve inside diameter is too small, the wear sleeve could become fractured or “split” during assembly. Also, if there is a misalignment between the center of the wear seal member and the center of the shaft (i.e., the axis of rotation), the wear sleeve could either become “squeezed” between the seal and shaft, and possibly split, or may not sufficiently occupy the space between the shaft outer surface and the inner surface of the wear sleeve such that leakage occurs.

Hence, there is a need for an improved fluid seal assemblies and methods to eliminate need for the wear sleeve and will solve problems associated with prior art designs such as static leakage of oil, constant wear and tear and replacement of parts that negatively impact lifecycle of the fluid seals. The inventive concept as set forth further below improves the aforementioned prior art wear sleeve designs.

### SUMMARY OF THE INVENTION

A fluid seals assembly (the assembly) of the present invention has numerous applications including and not limited to sealing vehicular engine crankshafts, transmission shafts, bearing lubrication systems, compressor shaft support assemblies, and the like. The assembly is disposed between an outer surface, i.e. a housing or an engine block or any other part that requires application of the assembly and a rotatable member, such as, for example a shaft, wherein the assembly circumscribes the shaft and lubricated the shaft as the same rotates around the axis.

The assembly includes a casing unit and a sealing ring or unit. The casing unit presents a rigid member having a side wall and a flange radially extending from the side wall. The side wall terminates into a free end. The sealing ring includes a sleeve portion defining active and reverse surfaces. An intermediate member or a ring is sandwiched between the shaft and the active surface of the sealing ring. A ring presents a circular cross section defining a diametrical line. The ring further includes an inner circumferential surface defining a first apex and an outer circumferential surface defining a second apex. The inner circumferential surface is engageable by and is retained on the outer surface of the shaft. The outer circumferential surface engages the active surface of the ring. Alternatively, the assembly includes a second ring having a circular cross section defining a diametrical line and presenting an inner circumferential surface defining a third apex and an outer circumferential surface defining a forth apex. Both rings may be connected to or spaced from one another.

In still another alternative embodiment of the present invention a ring presents a pumping surface defined by a sinuous line forming waves extending along the pumping surface of the ring for continuously lubricating the shaft rotatable relative the sealing ring as lubricant circulates about the waves along the pumping surface. The ring prevents frictional engagement between the sealing ring and the shaft thereby eliminating need for the prior art wear sleeve and, in fact, serves additional purpose, such as pumping the lubricant thereby constantly lubricating the shaft to expand the lifespan of the assembly.

An advantage of the present invention is to provide a fluid seal assembly that eliminates need for a wear sleeve.

Another advantage of the present invention is to provide the improved fluid seal assembly with a ring that will replace the aforementioned wear sleeve thereby eliminating issues of misalignment between the center of the wear seal member and the center of the shaft.

Still another advantage of the present invention is to provide the improved fluid seal assembly with the ring for preventing frictional engagement between the shaft and the sealing ring thereby servicing the seal assembly by replacing the ring without disassembling the entire seal assembly.

Still another advantage of the present invention is to provide the improved fluid seal assembly that eliminates problems associated with prior art designs such as static leakage of oil that negatively impact lifecycle of the fluid seal assembly.

Still another advantage of the present invention is to provide the fluid seal assembly that is cost effective in manufacturing and reduces the overall cost of the fluid seal assembly.

Still another advantage of the present invention is to provide a fluid seal assembly that includes a ring presenting a pumping surface with a pumping feature for continuous lubrication of the shaft and to prevent wear and tear of the sealing ring as the same rotates relative the shaft thereby increasing lifespan of the assembly.

Still another advantage of the present invention is to provide the fluid seal assembly that replaces prior art designs of the fluid seals having hydrodynamic features, such as unidirectional or bi-directional spirals, being cut or formed into the wafer portion of the seal which contacts with the rotatable shaft, thereby clogging these spirals with carbonized oil, which leads to reduction of the lifespan of the fluid seal assembly.

Other advantages and meritorious features of this invention will be more fully understood from the following description of the preferred embodiment, the appended claims, and the drawings; a brief description of which follows.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 illustrates a prior art design of a fluid seal assembly including a casing unit, a flexible sealing member, a shaft with the casing unit surrounding the shaft, and a wear sleeve being sandwiched between the shaft and the sealing member and mounted to the shaft at the sealing location;

FIG. 2 illustrates a partial cross sectional view of a seal assembly of the present invention presenting a sealing member surrounding a shaft and an intermediate member or a ring surrounding and mounted on the shaft and sandwiched between the shaft and the sealing member;

FIGS. 3 and 4 illustrate partial cross sectional views of a seal assembly of a first embodiment and a second embodiment presenting the sealing member surrounding the shaft and the intermediate member or the ring surrounding and mounted on the shaft and sandwiched between the shaft and the sealing member;

FIG. 5 illustrates a partial cross sectional and fragmental view wherein the shaft defines a peripheral groove to receive the ring surrounding and mounted on the shaft and sandwiched between the shaft and the sealing member;

FIG. 6 illustrates a partial cross sectional and fragmental view of a first alternative arrangement including two of the rings adjacently mounted on the shaft and sandwiched between the shaft and the sealing member;

FIG. 7 illustrates a partial cross sectional and fragmental view of a second alternative arrangement including two of the rings spaced from one another and mounted on the shaft and sandwiched between the shaft and the sealing member; and

FIGS. 8 and 9 illustrate various views of yet another alternative embodiment of the ring presenting pumping features for constant lubrication of the shaft.

### DETAILED DESCRIPTION OF THE INVENTION

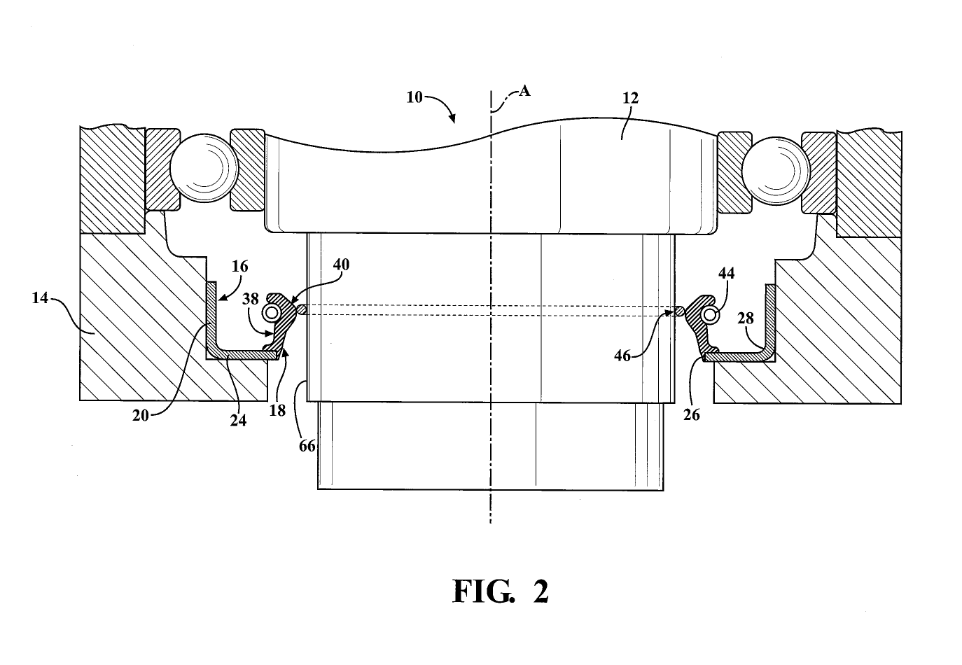

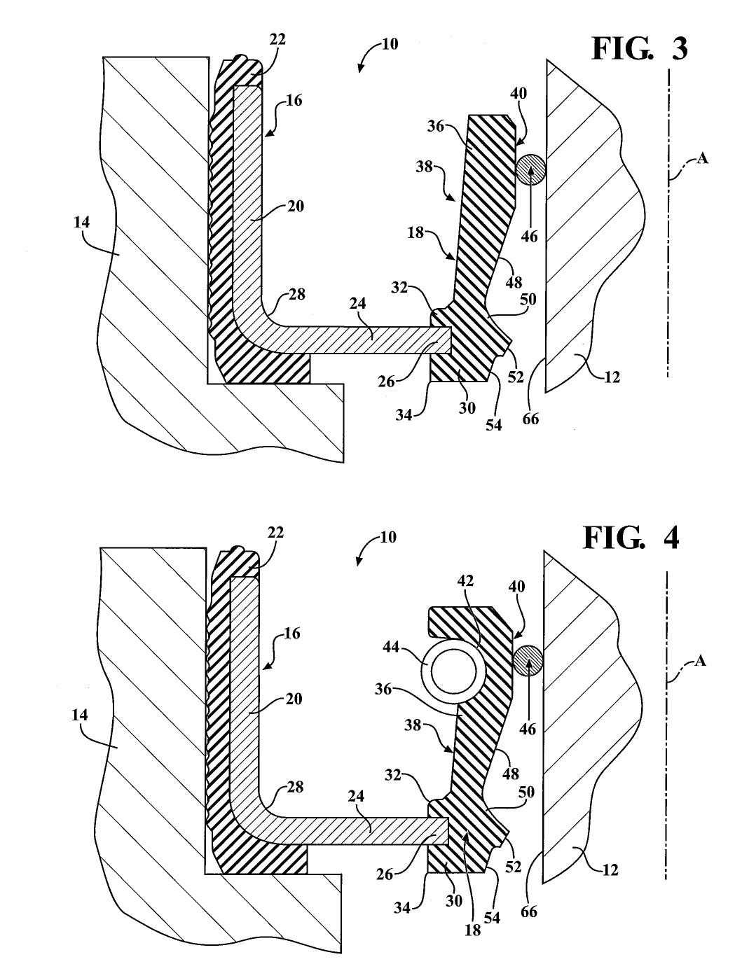

Referring to the Figure, wherein like numerals indicate like or corresponding parts throughout the several views, a fluid seal assembly (the assembly) of the present invention is generally shown at 10 in FIGS. 2 through 4. The assembly 10 has numerous applications including and not limited to sealing vehicular engine crankshafts, transmission shafts, bearing lubrication systems, compressor shaft support assemblies, and the like, without limiting the scope of the present invention. FIG. 2, for example, illustrates an environment, wherein the assembly 10 is disposed between a counterpart, such as a shaft 12, rotatable around an axis of rotation A, and a surface, such as an engine wall 14 or a housing of the kind. Those skilled in the mechanical art will appreciate that the shaft 12 and the engine wall 14 are shown for exemplary purposes only and are not intended to limit the scope of the present invention.

Referring back to FIG. 2, the assembly 10 includes a casing unit, generally indicated at 16, and a sealing ring, generally indicated at 18. The casing unit 16 presents a rigid member having a side wall 20 presenting a bonding portion 22 and a flange portion 24 extending outwardly from the side wall 20. The flange portion 24 terminates into a free end 26. The flange portion 24 and the side wall 20 present a radius portion 28 defined therebetween.

The sealing ring 18 is secured to the flange portion 24 of the casing unit 16 through a collar member 30. The collar member 30 includes a neck portion defined by an upper lip or inner bonding portion 32 and a lower lip or an outer bonding portion 34 defining a nest or a void therebetween to sandwich the side wall 16.

The sealing ring 18 further includes a body 36 presenting a reverse surface, generally indicated at 38, and an active surface, generally indicated at 40. In one of the embodiments illustrated in FIG. 4, for example, a spring retention groove 42 is formed in the reserve surface 38 to retain a spring 44 thereby applying external pressure to an intermediate member or a ring, generally indicated at 46, circumscribing the shaft 12. A plurality of converging walls 48, 50, 52, and 54 are defined in the active surface 40 of the sealing ring 18. The seal ring 18 is formed from any suitable elastomeric materials, such as rubber, silicone, polyacrylic, fluoroelastomer, ethylene acrylic, hydrogenated nitrile or nitrile elastomer. The sleeve 44 may also be formed from other materials such as, for example, polytetrafluoroethylene (PTFE) without limiting the scope of the present invention. The sealing ring 18 is injection molded but may be formed by many other suitable methods without limiting the scope of the present invention.

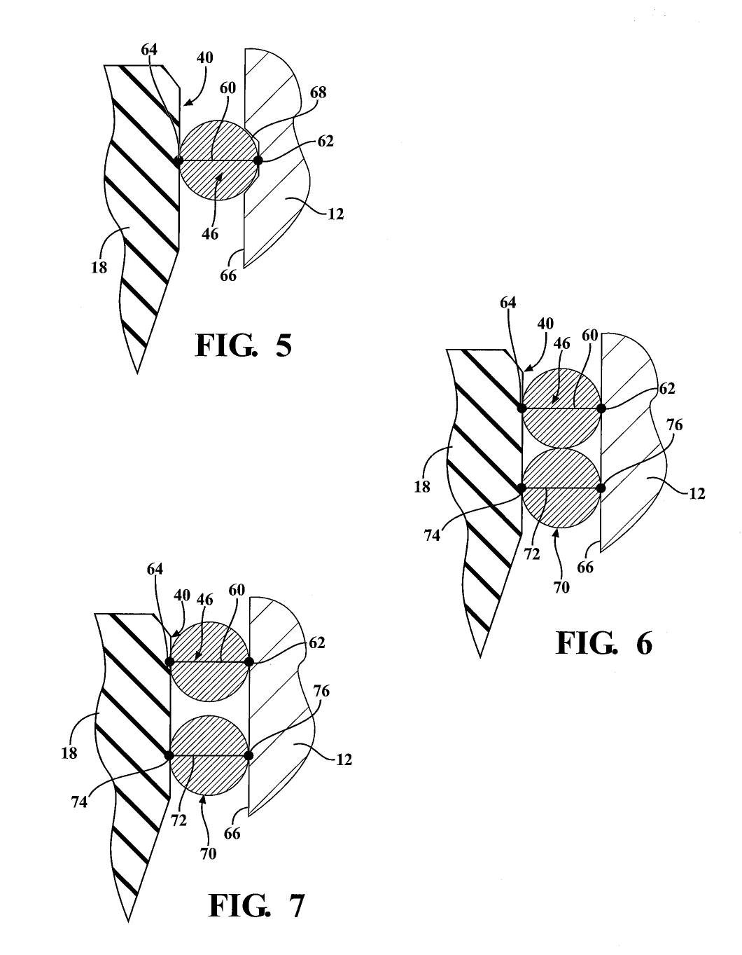

As best shown in FIGS. 5 through 7, the ring 46 is sandwiched between the shaft 12 and the active surface 48 of the sealing ring 18. The ring 46 presents a circular cross section defining a diametrical line 60. The ring 46 further includes an inner circumferential surface defining a first apex 62 and an outer circumferential surface defining a second apex 64. The inner circumferential surface is engageable at the apex 62 by and is retained on the outer surface 66 of the shaft 12 and the outer circumferential surface at the second apex 64 engaging the active surface 40 of the ring 46. The shaft 12 includes a groove 68 formed in the outer surface 66 of the shaft 12 to receive and hold the ring 46 thereby preventing movement of the ring 46 relative the shaft 12.

As best illustrated in FIGS. 6 and 7, the assembly 10 includes a second ring, generally indicated at 70, having a circular cross section defining a diametrical line 72 and presenting an inner circumferential surface defining a third apex 76 and an outer circumferential surface defining a forth apex 74. Both rings 46 and 70 may be connected to one another, as shown in FIG. 6, or spaced from one another, as shown in FIG. 7, without limiting the scope of the present invention. Both rings 46 and 70 may be formed from a wire fabricated from metals, metal alloys without limiting the scope of the present invention. The wire is then welded and measured to closely fit on the outer surface 66 of the shaft 12 by snapping or fitting into the groove 68. Both rings 46 and 70 may present a rectangular cross section without limiting the scope of the present invention. The rings 46 and 70 are provided to add additional stability, alignment between the shaft 12 and the seal ring 18.

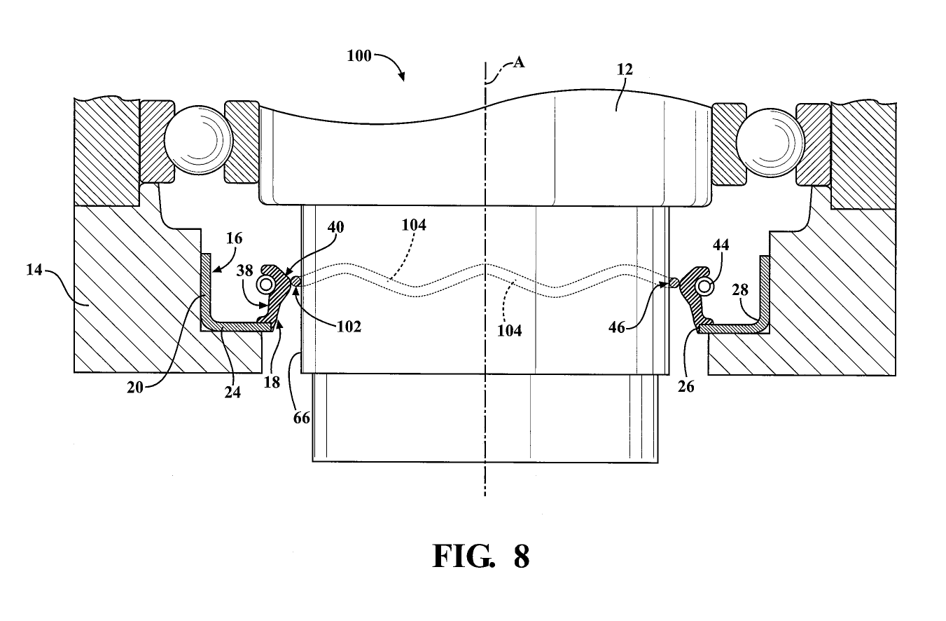

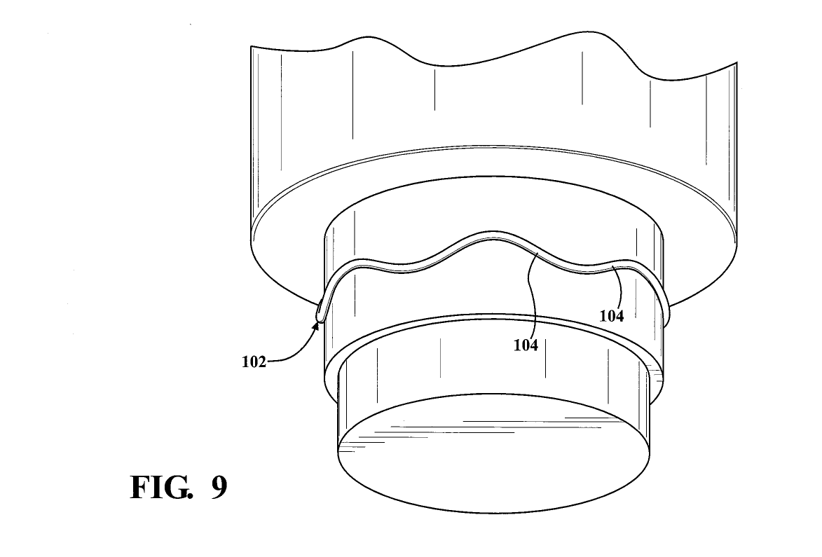

FIGS. 8 and 9 illustrate yet another embodiment of the assembly, generally shown at 100. A ring, generally indicated at 102, presents a circular cross section and a pumping surface defined by a sinuous line forming multiple waves 104 extending along the pumping surface of the ring 102 for continuously lubricating the shaft 12 rotatable relative the sealing ring 18 as lubricant circulates about the waves 104 along the pumping surface. The ring 102 prevents frictional engagement between the sealing ring 18 and the shaft 12 thereby eliminating need for the prior art wear sleeve and, in fact, serves additional purpose, such as pumping the lubricant thereby constantly lubricating the shaft 12 to expand the lifespan of the assembly 10.

A method of forming the seal assembly 10 with forming the casing unit 16 having the side wall 20 and the flange extending radially from the side wall 20. The casing unit 16 is formed by stamping as known to those skilled in the stamping art without limiting the scope of the present invention. The sealing ring 18 is fabricated by injection molding process and is connected to the flange 24. Alluding to the above, the ring 46 is formed from a wire fabricated from metals, metal alloys without limiting the scope of the present invention. The wire is then welded, machined, if required, and measured to closely fit on the outer surface 66 of the shaft 12 by snapping or fitting into the groove 68. The length of the wire is predetermined based on outer diameters of each shaft as each shaft may wary in its dimensions.

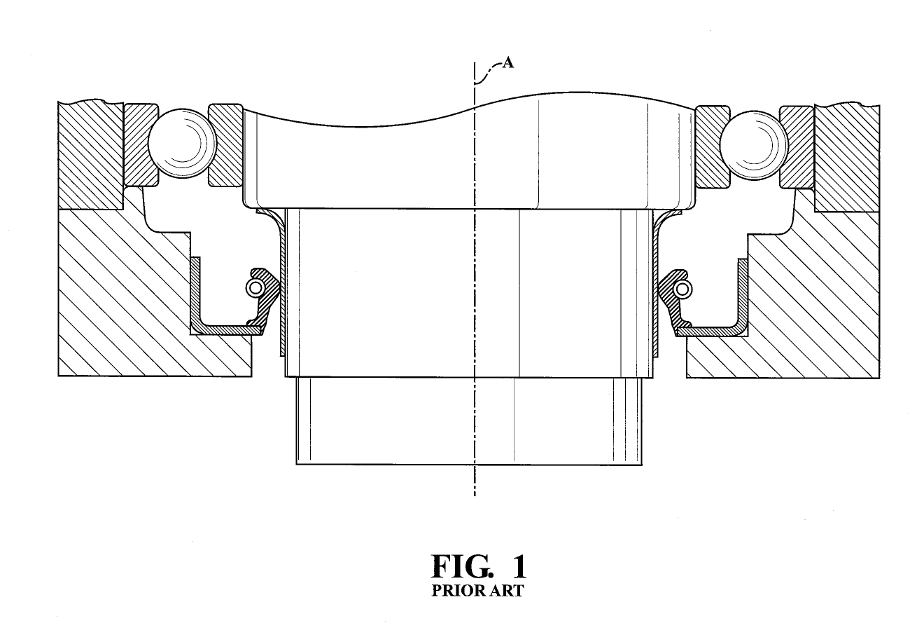

The ring 46 provides numerous advantages over prior art wear sleeve design as illustrated in FIG. 1. First of all, the ring 46 eliminates need for a wear sleeve, as one illustrated in FIG. 1, which is thin-walled and press-fitted onto the shaft that could become fractured or “split” during assembly. Another advantage of the present invention is implementation of cost saving solution whereby the ring 46 replaces the aforementioned wear sleeve to reduce misalignment between the center of the wear seal and the center of the shaft.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

I claim:

1. A seal assembly for providing a seal between a housing and a shaft having an outer surface and being rotatable around an axis and relative the housing, said seal assembly comprising:
a casing unit defined by a side wall and a flange extending radially from said side wall;
a sealing ring secured to said flange and presenting an active surface surrounding the shaft; and
a ring having a circular cross section defining a diametrical line and presenting an inner circumferential surface defining a first apex and an outer circumferential surface defining a second apex with said inner circumferential surface being engageable by and retained on the outer surface of the shaft and said outer circumferential surface engaging said active surface of said ring for preventing frictional engagement between the shaft and said sealing ring thereby servicing said seal assembly by replacing said ring without disassembling the entire seal assembly.

2. A seal assembly as set forth in claim 1, wherein said the shaft includes a groove formed in the outer surface of the shaft to receive and hold said ring thereby preventing movement of said ring relative the shaft.

3. A seal assembly as set forth in claim 1, including a second ring having a circular cross section defining a diametrical line and presenting an inner circumferential surface defining a third apex and an outer circumferential surface defining a forth apex with said ring and said second ring connected to one another.

4. A seal assembly as set forth in claim 3, wherein said ring and said second ring are spaced from one another.

5. A seal assembly as set forth in claim 4, wherein said ring and said second ring are formed from a metal wire.

6. A seal assembly as set forth in claim 1, wherein said ring presents a pumping surface defined by a sinuous line forming waves along said pumping surface for continuously lubricating the shaft rotatable relative said sealing ring as lubricant circulates about said waves along said pumping surface and preventing frictional engagement between said sealing ring and the shaft.

7. A seal assembly as set forth in claim 1, wherein said sealing ring includes a sleeve portion defining said active surface and a reverse surface, a collar member connected to said sleeve portion to secure said sleeve portion to said flange.

8. A seal assembly as set forth in claim 7, wherein said sealing ring is formed from at least one of elastomeric materials, such as silicone, polyacrylic, fluoroelastomer, ethylene acrylic, polytetrafluoroethylene.

9. A seal assembly as set forth in claim 8, wherein said sleeve portion presents a spring retention groove defined in said reversed surface to retain a spring.

10. A seal assembly for providing a seal between a housing and a shaft having an outer surface and being rotatable around an axis and relative the housing, said seal assembly comprising:
a casing unit defined by a side wall and a flange extending radially from said side wall;
a sealing ring secured to said flange and presenting an active surface surrounding the shaft wherein said sealing ring includes a sleeve portion defining said active surface and a reverse surface;
a ring having a circular cross section defining a diametrical line and presenting an inner circumferential surface defining a first apex and an outer circumferential surface defining a second apex with said inner circumferential surface being engageable by and retained on the outer surface of the shaft and said outer circumferential surface engaging said active surface of said ring; and
a second ring having a circular cross section defining a diametrical line and presenting an inner circumferential surface defining a third apex and an outer circumferential surface defining a forth apex with said ring and said second ring connected to one another.

11. A method of forming a seal assembly to provide a seal between a shaft and a housing with the shaft rotatable around a central axis and relative the housing, said method comprising the steps of:
forming a casing unit having a side wall and a flange extending radially from the side wall;
forming a sealing ring secured to said flange and having an active surface surrounding the shaft; and
snapping a ring having a circular cross section onto the shaft whereby the ring defines a diametrical line and presents an inner circumferential surface defining a first apex and an outer circumferential surface defining a second apex with the inner circumferential surface being engageable by and retained on the outer surface of the shaft and the outer circumferential surface engaging the active surface of the ring to prevent frictional engagement between the shaft and the sealing ring and to service the seal assembly by replacing the ring without disassembling the entire seal assembly.

12. A method as set forth in claim 11, including the step of forming a groove in the outer surface of the shaft to receive and hold the ring to prevent movement of said ring relative the shaft.

13. A method as set forth in claim 11, including the step of snapping a second ring having a circular cross section defining a diametrical line and presenting an inner circumferential surface defining a third apex and an outer circumferential surface defining a forth apex.

14. A method as set forth in claim 13, including the step of connecting the ring and said second ring to one another.

15. A method as set forth in claim 14, including the step of forming the ring and the second ring from a metal wire.

16. A seal assembly for providing a seal between a housing and a shaft having an outer surface and being rotatable around an axis and relative the housing, said seal assembly comprising:
a casing unit defined by a side wall and a flange extending radially from said side wall;
a sealing ring secured to said flange and presenting an active surface surrounding the shaft; and
a ring having a circular cross section and presenting a pumping surface defined by a sinuous line forming waves along said pumping surface for continuously lubricating the shaft rotatable relative said sealing ring as lubricant circulates about said waves along said pumping surface and preventing frictional engagement between said sealing ring and the shaft.

17. A seal assembly as set forth in claim 16, wherein said ring is formed from a metal wire.

18. A seal assembly as set forth in claim 16, wherein said sealing ring includes a sleeve portion defining said active surface and a reverse surface.
